(19) United States
(12) Patent Application Publication
(10) Pub. No.: US 2022/0032609 A1
(43) Pub. Date: Feb. 3, 2022

(54) METHOD AND SYSTEM FOR THE DETECTION AND CORRECTION OF PRINTING DEFECTS OF A PRINTING DEVICE

(71) Applicant: NEOS S.r.l., Fiorano Modenese (MO) (IT)

(72) Inventor: Vincenzo Palumbo, Fiorano Modenese (MO) (IT)

(73) Assignee: NEOS S.r.l., Fiorano Modenese (MO) (IT)

(21) Appl. No.: 17/280,483

(22) PCT Filed: Sep. 30, 2019
(86) PCT No.: PCT/EP2019/076372

§ 371 Date: Mar. 26, 2021

(30) Foreign Application Priority Data
Sep. 28, 2018 (EP) 18425076.9

(51) Int. Cl. B41J 2/045; G06K 15/10; G06K 15/00; G06K 15/02

(52) U.S. Cl. CPC B41J 2/0451; G06K 15/102; B41J 2/04586; G06K 15/027; G06K 15/408

(57) ABSTRACT

Method and respective device for the detection and correction of printing defects of a digital printing device (A) comprising the following steps: —arranging a digital printing device (A) equipped with one or more print heads (H) with a plurality of dispensing nozzles (N); —continuously controlling said plurality of dispensing nozzles (N) to realize a real printing pattern (RPP) on a printing medium (P); —continuously acquiring the real printing pattern (RPP); —detecting at least one printing defect (DF); —elaborating, onboard a control unit of the digital printing device (A), at least one compensation scheme to mask a detected printing defect (DF,); —applying said compensation device during the realization of said real printing pattern (RPP).

### FIELD OF APPLICATION

The present invention relates to a method for the detection and correction of printing defects.

The invention also relates to a system that realizes said method.

In particular, the invention may find useful application in various technological fields where industrial printing is required on surfaces of even large dimensions, for instance in the printing on paper, corrugated cardboard, cardboard, plastic film, thermoplastic sheets; namely in the printing of labels, packaging, signs or even ceramic or assimilable coatings.

### BACKGROUND ART

In all of the fields identified in the previous paragraph, printing devices adopting one or more print heads are used, said print heads being typically side by side to each other, so as to define a fixed printing area below which a printing medium slide.

The above print heads have a plurality of nozzles, each of which is arranged to release a volume of ink that impresses onto the printing medium, realizing an ink point that cooperates with the other ones, so as to define an image.

One of the known problems of the printing devices of the type herein considered relates to the high frequency of malfunction of the single nozzles of the print head, which results in even evident printing defects, such as for example the presence of marked white stripes or in any case with a colour density less than the desired one on the printed image.

Another known printing defect is linked to the tone unevenness among the various nozzles of a single print head and/or among the different print heads which constitute a given colour.

When the presence of the above defects results in an insufficient print quality for the reference application, it is generally necessary to replace the single damaged print head, with significant economic damage due to the relatively high cost of these components.

By the way, the recent technological development of the print heads allows today, at least in some of the high-end models, an extremely precise dosage—in the order of picolitres—of the volume of ink released by each single nozzle. Thanks to said possibility of control, correction systems have been introduced, which mask the printing defect, caused by the defectiveness of one or more nozzles, by modifying the volume of ink dispensed by adjacent nozzles.

However, said control systems, though representing a great improvement with respect to the prior art, realize a pre-set compensation during the testing phase, which does not always ensure optimal print quality in the concrete use.

Another limitation of the digital printing devices according to the prior art is the need to make adjustments for the setup during start-up phase, for instance relating to the overlap of the modules of adjacent nozzles or the alignment of the modules of the different colours. Said adjustments are time-consuming and delay the start of the production phases.

Documents US 2012/050377 A1, US 2018/086049 A1 and US 2014/313255 disclose method for the detection and correction of printing defects according to the prior art.

Therefore, the technical problem underlying the present invention is to improve the quality of the known prior art correction and setup systems, ensuring high print quality over time and significantly extending the useful life of the individual print heads of the digital printing device.

### SUMMARY OF THE INVENTION

The previously identified technical problem is solved by a method for the detection and correction of printing defects of a digital printing device comprising the following steps:
arranging a digital printing device equipped with one or more print heads with a plurality of dispensing nozzles placed along a printing area;
arranging an optical detection system, placed next to said printing area with reference to a printing direction;
controlling said plurality of dispensing nozzles for dispensing ink onto a printing medium, relatively movable with respect to said printing area, said dispensing being performed based on a predefined ideal printing pattern comprising one or more levels of grey, said dispensing realizing a real printing pattern on said printing medium;
acquiring the real printing pattern through said optical detection system;
detecting at least one printing defect defined by a difference of said real printing pattern acquired by the optical detection system with respect to said ideal printing pattern;
elaborating, on board a control unit of the digital printing device, a compensation scheme to mask the printing defect;
applying said compensation scheme during the realization of said real printing pattern.

The method provides for subsequent steps of acquiring again the real printing pattern (RPP) through said optical detection system (OD) after realizing the real printing pattern (RPP) with the applied compensation scheme; and modifying said compensation scheme in feedback control to make the visual appearance of said real printing pattern, acquired by the optical detection system, similar to the visual appearance of the ideal printing pattern.

A feedback control is a closed loop control in which a control variable is modified in view of a discrepancy between a setpoint and a measured variable, so that the discrepancy is minimized over time.

The steps realizing the real printing pattern with the applied compensation scheme, acquiring again the real printing pattern and modifying said compensation scheme in feedback control may be advantageously repeated until a desired degree of similarity is achieved between said real printing pattern and said ideal printing pattern.

The above outlined method advantageously allows performing a dynamic control of the compensation scheme, adapting it based on the actual printing conditions in use, linked for example to the real operating parameters of the involved specific adjacent nozzles.

On the contrary, the prior art methods apply pre-set and theoretical schemes, derived from a calibration carried out during the testing phase and not repeatable during the useful life of the printing device.

Instead, it should be emphasized how the above described method can be applied both in an initial testing phase, and above all at later times in the device life, for example before a print job.

The method can even be used as a production dynamic control, namely monitoring the print quality and intervening in real time to correct any detected defects.

In a specific example, the similarity between the real printing pattern and an ideal printing pattern having a uniform color field is evaluated through an algorithm that assesses differences in color density within a field of the real printing pattern corresponding to the uniform color field of the ideal printing pattern.

In a specific example, the method may comprise the identification of at least one defective dispensing nozzle responsible for a printing defect, based on the linear position of said printing defect along the printing area.

In this case, the compensation scheme provides for the dispensing variation of one or more dispensing nozzles close to said defective dispensing nozzle to mask the detected printing defect.

The compensation scheme may concretely result, for instance, in an increase in the ink volumes of one or more nozzles placed close to the defective nozzle: for instance, an amount of additional ink can be set to be dispensed to one or both nozzles which are side by side the defective nozzle along the printing area.

The method may also comprise the identification of other printing defects, besides or alternatively to the identification of the defective dispensing nozzles.

One of these defects is the tone unevenness (a problem known in the field as “banding”). Said defect is always detected as a difference between ideal dispensing pattern and real dispensing pattern: however, in this case, there is not a total lack of a line, but rather a difference in tone which can be punctual or related to an area (group of nozzles or entire print head).

In this case, different alternative compensation schemes can be adopted.

A first compensation scheme provides for the variation of the drop volumes of the nozzles which insist on the areas affected by the defect. This can be done by singularly intervening on the nozzles, analogously to what has been previously described for the defective nozzle correction, or by intervening on parameters (for instance the supply voltage of the piezoelectric actuators) which affect an entire group of dispensing nozzles.

An alternative compensation scheme instead acts on image processing, through the printing RIP, modifying the density of the printing pixels in the areas affected by the phenomenon.

The method may further comprise an acquisition step of specific information related to the setup during start-up phase, so that the elaborated compensation scheme performs said adjustment.

In particular, the specific information may relate to the overlap among modules of adjacent nozzles. It is in fact known that the overlap among modules may cause local defects which result in missing or darkened lines. The detected information, obtained through the printing and the subsequent detection of a specific print test, relates in this case to the optimal choice of the overlapping nozzles, namely the definition of an optimal overlap scheme.

Another information detectable through specific test and useful during setup phase of the printing device relates to the alignment between the modules of dispensing nozzles relating to the different colours.

The same architecture, exploiting the same optical detection system (preferably with CIS sensors), may also be used to get information that enables the digital printing device to be profiled.

As previously mentioned, at least the steps of detecting a printing defect, of elaborating a compensation scheme and of applying the compensation scheme can be performed during a production cycle of the digital printing device.

In particular, the use of the method during the production cycle turns out to be particularly effective for the detection of the unevenness defects (“banding”). In fact, the Applicant has already found out how the system according to the present patent easily allows identifying said defects through the optical monitoring of the printed graphics, even at relatively high speeds (indicatively greater than 80 m/min) used in the production step.

It should also be noted that, in order to apply the method during the production cycle, test graphics may also be used during printing in a printing medium scrap. The analysis of the optical detection system can thus be performed on said test graphics. However, the Applicant has found out that the use of such test graphics is not strictly necessary, since it is also possible to perform the error detection directly on the production graphics.

The feedback control step may be useful in this case to monitor in real time whether the compensation scheme defines an acceptable correction.

Advantageously, during the step of modifying said compensation scheme in feedback control, an optimal compensation scheme can be obtained, which is applicable in subsequent printing operations of the digital printing device.

Therefore, said optimal compensation scheme can be stored on a storage medium which is accessible to a control unit of the printing device, so that the scheme can be applied in subsequent printing.

In particular, said step of modifying said compensation scheme in feedback control can be used and repeated to identify a plurality of optimal compensation schemes relating to different levels of grey.

In fact, the compensation will probably be different according to the requested level of grey, namely due to the colour density of the pixels of the ideal printing pattern placed at the defective dispensing nozzle.

Thus, the method according to the present invention, in the presence of a defective nozzle, will identify an alternative compensation scheme for different levels of grey and the digital printing device will then apply the corresponding scheme where the image to be printed has that specific level of grey at the area where the printing defect has been detected.

Obviously, in case of colour printing different groups of nozzles are present, each of which dispenses ink of different colour. The method according to the present invention in this case can be performed consecutively—but preferably still within the same printing—for each of the groups of nozzles.

In a manner per se known, one of the ideal printing patterns used to identify and correct the printing defects, preferably performed in a preliminary test phase or in portions of the medium not affected by the graphics printed in production, comprises more portions, subsequently placed along the printing direction, each of which comprises a homogeneous area with a different level of grey. Other ideal printing patterns may comprise pluralities of lines in the feed direction of the printing medium, for identifying the defective nozzles, or still different homogeneous blocks with selective use of the dispensing nozzles placed at the overlapping between the modules of subsequent nozzles of the digital printing device.

Preferably, said optical detection system is provided with a plurality of scanning sensors linearly distributed along the printing area.

Each of said scanning sensors is preferably adapted to linearly discriminate between ink points released by contiguous dispensing nozzles of the print head.

In a possible embodiment, each single scanning sensor is placed in linear correspondence with a single dispensing nozzle.

In an alternative and preferred embodiment, a single scanning sensor is placed in linear correspondence with more adjacent dispensing nozzles (preferably two per sensor) of the print head, said scanning sensors being able to discriminate the ink points related to the adjacent dispensing nozzles.

In this case, in order to discriminate between the different nozzles to identify a possible malfunctioning nozzle, a print test is performed in which the adjacent nozzles are operated at a later time. Thus, the ideal printing pattern will comprise a series of subsequent modules of lines, each line being at a determined dispensing nozzle, the lines corresponding to the adjacent dispensing nozzles in linear correspondence with a single scanning sensor being realized in distinct modules of lines. The number of the subsequent modules of lines is at least equal to the number of nozzles per sensor, while further modules can possibly be used for other evaluations, for instance on the deviated nozzles.

The scanning sensors are preferably CIS sensors.

The previously identified technical problem is also solved by a system for the detection and correction of printing defects of a digital printing device, comprising:
a digital printing device equipped with one or more print heads with a plurality of dispensing nozzles placed along a printing area, arranged to dispense ink onto a printing medium, relatively movable with respect to said printing area, based on a predefined ideal printing pattern comprising one or more levels of grey, realizing a real printing pattern on said printing medium;
an optical detection system, placed next to said printing area with reference to a printing direction, arranged to acquire the real printing pattern;
a control unit arranged to:
   detect at least one printing defect defined by a difference of said real printing pattern acquired by the optical detection system with respect to said ideal printing pattern;
   elaborate, onboard a control unit of the digital printing device, at least one compensation scheme to mask a detected printing defect;
   apply said compensation scheme during the realization of said real printing pattern;
   after realizing the real printing pattern with the applied compensation scheme, acquiring again the real printing pattern through said optical detection system;
   modifying said compensation scheme in feedback control to make the visual appearance of said real printing pattern similar to the visual appearance of said ideal printing pattern.

The above control unit can also modify said compensation scheme in feedback control to make the visual appearance of said real printing pattern acquired by the optical detection system similar to the visual appearance of said ideal printing pattern.

It should be noted that the control unit can be mounted onboard the printing device or be external thereto. For instance, it can be an electronic computer interfaced with the digital printing device and with the optical detection system.

Further features and advantages will become more apparent from the following detailed description of two preferred, but not exclusive, embodiments of the present invention, with reference to the enclosed figures given by way of example and not for limiting purposes.

### BRIEF DESCRIPTION OF THE DRAWINGS

FIG. 1 schematically shows an ideal printing pattern used by the method and system for the detection and correction of printing defects of a digital printing device according to the present invention;

FIG. 2 schematically shows a system for the detection and correction of printing defects of the method according to the present invention;

FIG. 3 schematically shows the system in a correction step of the error detected in the step shown in FIG. 2;

FIG. 4 schematically shows a first variant of the system of FIG. 2, in which in particular the sensors that constitute the optical detection system are highlighted;

FIG. 5 schematically shows a second variant of the system of FIG. 2, in which in particular the sensors that constitute the optical detection system are highlighted;

FIG. 6 schematically shows the system of FIG. 2 during another detection step of the method according to the present invention;

FIG. 7 schematically shows the system according to the present invention during a correction step of the error detected in the step shown in FIG. 6.

### DETAILED DESCRIPTION

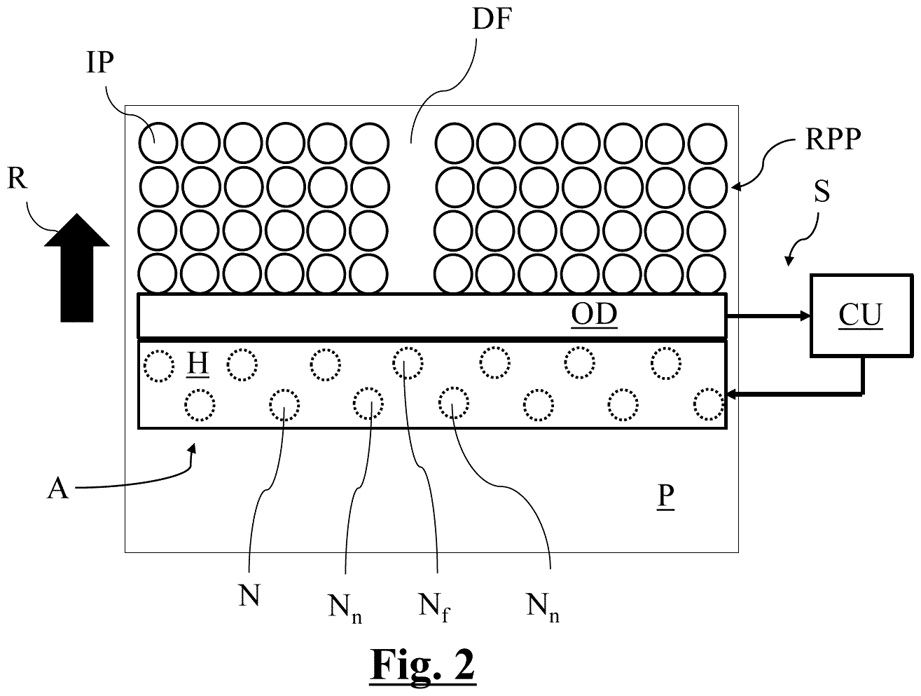

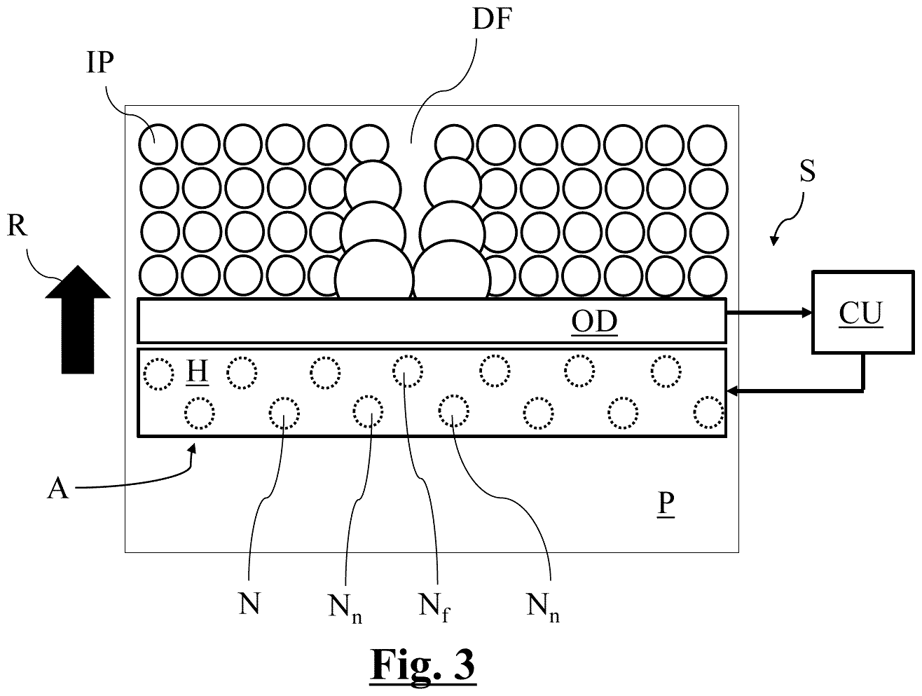

With reference to the enclosed FIGS. 2-7, S generally identifies a system for the detection and correction of printing defects.

The system S comprises in particular a digital printing device A, preferably for flat printing, comprising one or more print heads H which are side by side to each other so as to define a printing area. Preferably, the defined printing area is of a large dimension, in particular equal to or greater than two meters.

For the sake of simplicity of representation, in the enclosed figures a unique print head H is represented.

The print head H, of a per se known type, has a plurality of dispensing nozzles N arranged to dispense a volume of ink which is adjustable in a fine manner and in real time. The instantaneous dispensing of a single nozzle N onto a printing medium P locally defines an ink point IP; the different ink points IP cooperate to define a printing image.

The dispensing nozzles N are preferably arranged in an offset manner, for reasons linked to dimensions and to the internal structure of the print head itself. Nevertheless, to each single dispensing nozzle N a specific position on the printing area corresponds, so that said dispensing nozzles N can be ideally considered to be side by side to each other. In the following of the present description, the term “adjacent” related to the dispensing nozzles N refers to said ideal linear arrangement along the printing area.

The system S also comprises means for moving the aforementioned printing medium P, which are arranged for advancing said printing medium P in a feed direction orthogonal to the printing area, herein called printing direction R.

The system S also comprises an optical detection system OD, comprising a plurality of scanning sensors C, preferably of the CIS type, which are linearly side by side to each other along a direction parallel to the printing area.

The optical detection system OD is arranged downstream the digital printing device A and is arranged to acquire the image freshly printed said printing device A.

In particular, it should be noted that the optical detection system OD is able to discriminate the position of the ink points IP deposited by adjacent nozzles.

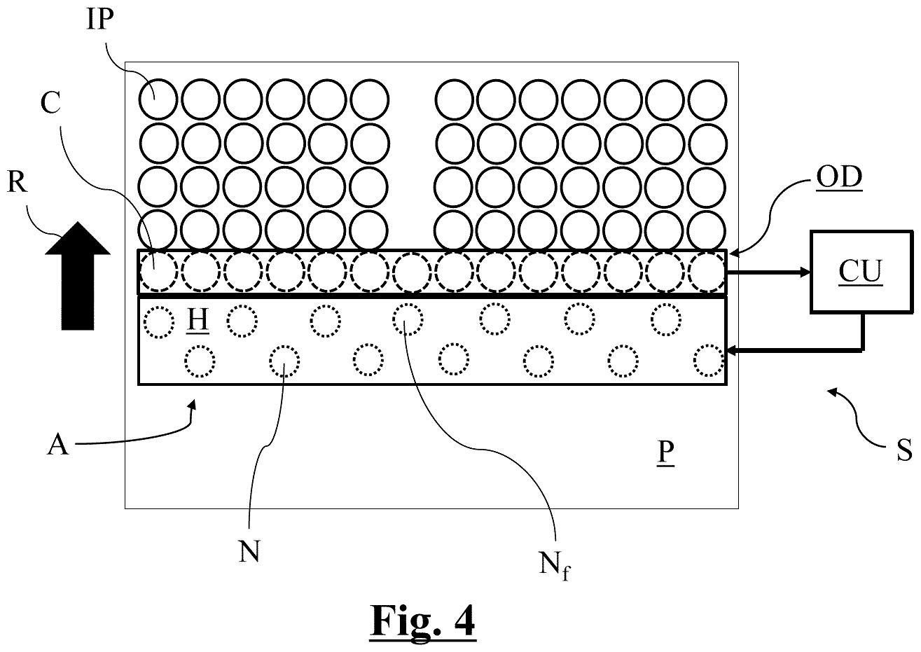

In a first variant, illustrated in FIG. 4, a single scanning sensor C is arranged at each dispensing nozzle N of the digital printing device A.

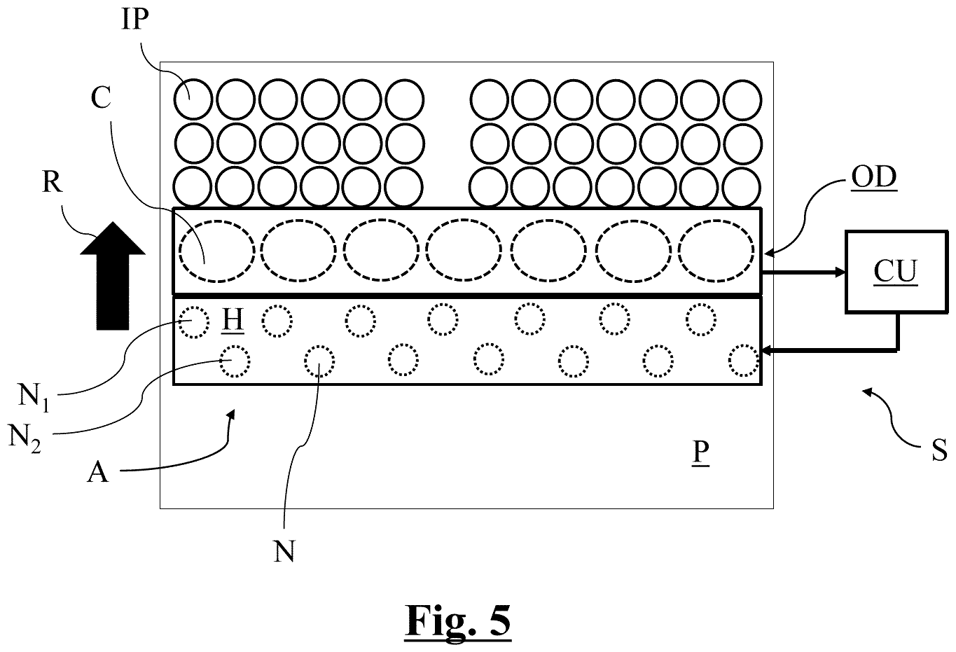

In a second variant, illustrated in FIG. 5, a scanning sensor C is instead arranged in front of each pair of adjacent dispensing nozzles N₁, N₂, which are offset to each other along the printing direction R.

The system S also comprises a control unit CU, which on the one hand controls the operation of the dispensing nozzles N, on the other hand acquires the signal of the optical detection system OD.

Said control unit CU, which can be realized by one or more computers, by one or more microprocessors or by analogous known devices, may comprise or be connected to a storage medium in which ideal compensation schemes, obtained from the method described below, will be stored.

The above system S is able to perform a method for the detection and correction of printing defects DF, DF2 and/or the setup during start-up phase of the previously described digital printing device.

A first printing defect DF detectable and correctable with the method according to the present invention is the presence of defective dispensing nozzles N_{f}.

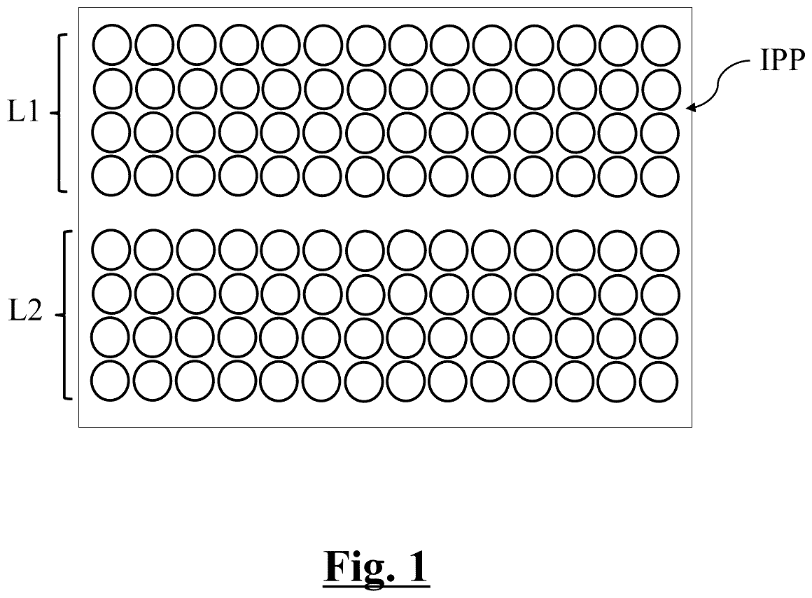

An example of how said defect DF can be detected and corrected is hereinafter provided, with specific reference to FIGS. 1-3.

In a first step, the digital printing device A is controlled to perform a print aimed at identifying and correcting the printing defects DF linked to the presence of defective dispensing nozzles N_{f}.

Said printing is preferably realized based on an ideal printing pattern IPP, namely a digital image made of a pixel array, illustrated in FIG. 1.

Said ideal printing pattern IPP comprises a plurality of subsequent bands L1, L2, each band comprising pixels of homogeneous colour intensity, particularly to each band a different level of grey corresponds.

The digital printing device A, as represented in FIG. 2, will thus print a real printing pattern RPP defined by the deposition of the ink points IP onto the printing medium P.

At defective dispensing nozzles N_{f}, the real printing pattern RPP will locally have a printing defect DF, represented in this case by a missing column or having a colour density less than the one of the corresponding area of the ideal printing pattern IPP.

Through the optical detection system OD, the control unit CU is able to identify the specific defective dispensing nozzle N_{f}.

In the specific case of the variant of FIG. 4, the position of the defective dispensing nozzle N_{f} is immediately deducible from the position of the scanning sensor C which detects the defect.

Instead, in the case of the variant of FIG. 5, it will be preferable to perform a different or further print test in which the two dispensing nozzles relating to each single sensor C are made to print—preferably: continuous lines—in two subsequent steps. In this way, the sensor resolution will be sufficient to identify the defective nozzle N_{f} in a timely manner.

Once the defective dispensing nozzle N_{f} has been identified, the control unit CU modifies the dispensing of the nozzles based on an initial compensation scheme, which substantially reassigns the volume of ink attributed to the defective dispensing nozzle N_{f} distributing it to the adjacent dispensing nozzles N₁, N₂.

At this point, in a preferred embodiment with error feedback control, the optical detection system OD continues its acquisition and will detect a real printing pattern RPP modified by the compensation scheme.

The control unit CU goes back comparing said real printing pattern RPP with the expected result, i.e. with the ideal printing pattern IPP.

Depending on the residual discrepancies, said control unit CU will modify the adopted compensation scheme and so on, until an acceptable overlap between real printing pattern RPP and ideal printing pattern IPP is achieved.

Thus, a feedback control of the adopted compensation scheme is carried out, which advantageously allows achieving an optimal compensation for each single printing defect DF that has been found.

In another embodiment, the compensation scheme can be adopted without a further feedback control, for instance during a production cycle following a preliminary detection printing.

A second printing defect DF2 detectable and correctable with the method according to the present invention is the presence of banding, i.e. areas having tone unevenness.

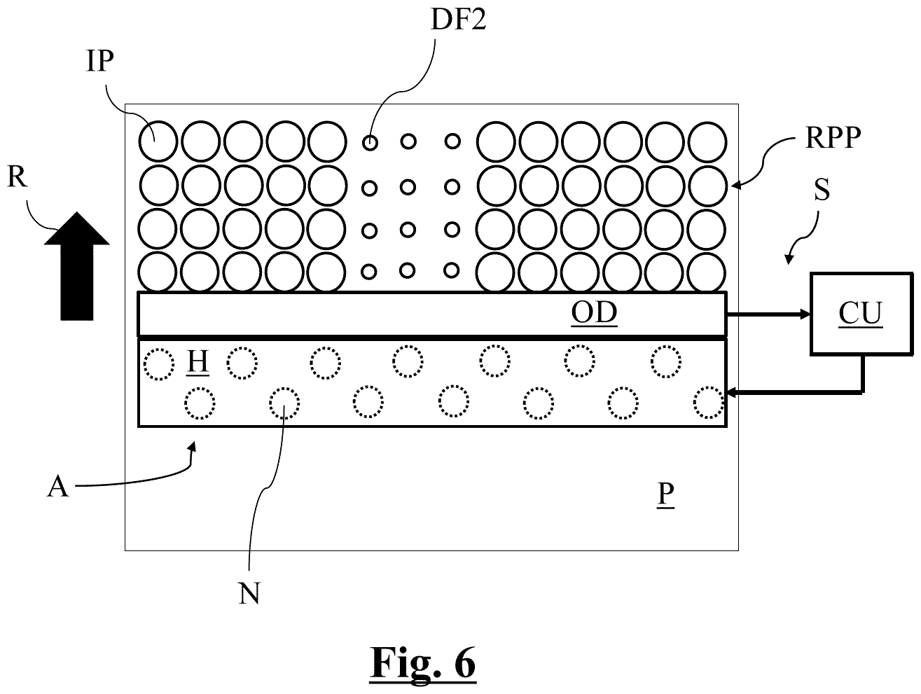

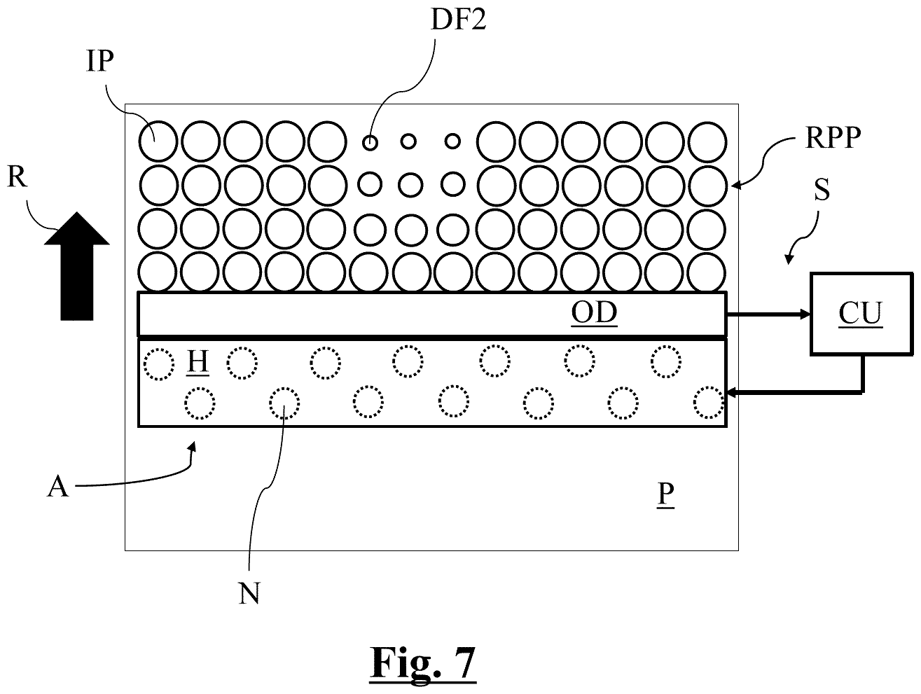

An example of how said defect DF can be detected and corrected is hereinafter provided, with specific reference to FIGS. 6-7.

In this case, the defect detection illustrated in FIG. 6 leads to a correction of the drop volume assigned to the dispensing nozzles N in the area affected by the phenomenon, thus realizing the correction visible in FIG. 7.

Other correction systems of banding can be employed, as widely described in the summary of the present invention.

The method and device according to the present invention are moreover able to detect, still with excellent performances and the possibility of a real time correction, other printing defects known in the field, besides automatically performing the setup of the printing device during a start-up phase.

Obviously, a skilled person can make several changes and variants to the above described invention, in order to meet contingent and specific needs, all of them by the way contained in the scope of protection of the invention as defined by the following claims.

1. A method for the detection and correction of printing defects of a digital printing device comprising the following steps:
arranging a digital printing device equipped with one or more print heads with a plurality of dispensing nozzles placed along a printing area;
arranging an optical detection system, placed next to said printing area with reference to a printing direction;
controlling said plurality of dispensing nozzles for dispensing ink onto a printing medium, relatively movable with respect to said printing area, said dispensing being performed based on a predefined ideal printing pattern comprising one or more levels of grey, said dispensing realizing a real printing pattern on said printing medium;
acquiring the real printing pattern through said optical detection system;
detecting at least one printing defect defined by a difference of said real printing pattern acquired by the optical detection system with respect to said ideal printing pattern,
elaborating, on board a control unit of the digital printing device, at least one compensation scheme to mask a detected printing defect;
applying said compensation scheme during the realization of said real printing pattern,
after realizing the real printing pattern with the applied compensation scheme, acquiring again the real printing pattern through said optical detection system;
modifying said compensation scheme in feedback control to make the visual appearance of said real printing pattern similar to the visual appearance of said ideal printing pattern.

2. The method for the detection and correction of printing defects according to claim 1, wherein the steps of realizing the real printing pattern with the applied compensation scheme, acquiring again the real printing pattern and modifying said compensation scheme in feedback control are repeated until a desired degree of similarity is achieved between said real printing pattern and said ideal printing pattern.

3. The method for the detection and correction of printing defects of a digital printing device according to claim 2, wherein at the end of the step of modifying said compensation scheme in feedback control, an optimal compensation scheme is obtained, which is applicable in subsequent printing operations of the digital printing device.

4. The method for the detection and correction of printing defects of a digital printing device according to claim 1, wherein the step of detecting at least one printing defect comprises the sub-step of identifying at least one defective dispensing nozzle responsible for the printing defect, and wherein the elaborated compensation scheme provides for the dispensing variation of one or more dispensing nozzles close to said defective dispensing nozzle.

5. The method for the detection and correction of printing defects of a digital printing device according to claim 1, wherein the step of detecting at least one printing defect comprises the sub-step of identifying a tone unevenness in the real printing pattern.

6. The method for the detection and correction of printing defects of a digital printing device according to claim 5, wherein the elaborated compensation scheme provides for the dispensing variation of one or more dispensing nozzles at the area affected by the tone unevenness, by intervening on the drop volume assigned to the single dispensing nozzles or on printing head adjustment parameters that affect an entire module of dispensing nozzles.

7. The method for the detection and correction of printing defects of a digital printing device according to claim 5, wherein the elaborated compensation scheme acts on the image processing, through the printing RIP, modifying the density of the printing pixels in the areas affected by the tone unevenness.

8. The method for the detection and correction of printing defects of a digital printing device according to claim 1, further comprising a step of detecting at least one setup information starting from the analysis of said real printing pattern, and a step of setting up the device during start-up phase based on said detected setup information, wherein the detected setup information starting from the analysis of said real printing pattern is an information on the overlap between the different adjacent modules of dispensing nozzles and/or the alignment between the different modules of dispensing nozzles related to the different colours.

9. The method for the detection and correction of printing defects of a digital printing device according to one of the previous claim 1, wherein at least the steps of detecting a printing defect, of elaborating a compensation scheme and of applying the compensation scheme can be carried out during a production cycle of the digital printing device.

10. The method for the detection and correction of printing defects of a digital printing device according to claim 9, wherein during the production cycle the feed speed of the printing medium with respect to the printing area is greater than 80 m/min.

11. The method for the detection and correction of printing defects of a digital printing device according to claim 1, wherein said optical detection system provides for a plurality of scanning sensors which are linearly distributed along the printing area.

12. The method for the detection and correction of printing defects of a digital printing device according to claim 11, wherein a single scanning sensor is placed in linear correspondence with a single dispensing nozzle.

13. The method for the detection and correction of printing defects of a digital printing device according to claim 11, wherein a single scanning sensor is placed in linear correspondence with two or more adjacent dispensing nozzles of the print head, said ideal printing pattern comprising two or more subsequent modules of lines, each line being at a determined dispensing nozzle, the lines corresponding to the adjacent dispensing nozzles in a linear correspondence with a single scanning sensor being realized in distinct modules of lines.

14. The method for the detection and correction of printing defects of a digital printing device according to claim 11, wherein said scanning sensors are CIS sensors.

15. A system for the detection and correction of printing defects of a digital printing device comprising:
a digital printing device equipped with one or more print heads with a plurality of dispensing nozzles placed along a printing area, arranged to dispense ink onto a printing medium, relatively movable with respect to said printing area, based on a predefined ideal printing pattern comprising one or more levels of grey, realizing a real printing pattern on said printing medium;
an optical detection system, placed next to said printing area with reference to a printing direction, arranged to acquire the real printing pattern;
a control unit arranged for:
detecting:
at least one printing defect defined by a difference of said real printing pattern acquired by the optical detection system with respect to said ideal printing pattern;
elaborating, on board a control unit digital printing device, at least one compensation scheme to mask a detected printing defect;
applying said compensation scheme during the realization of said real printing pattern,
after realizing the real printing pattern with the applied compensation scheme, acquiring again the real printing pattern through said optical detection system;
modifying said compensation scheme in feedback control to make the visual appearance of said real printing pattern similar to the visual appearance of said ideal printing pattern.
